(19) United States
(12) Patent Application Publication
(10) Pub. No.: US 2008/0039254 A1
(43) Pub. Date: Feb. 14, 2008

(54) CHAIN TENSIONER

(75) Inventors: Selichi NISHIHIRA, Wako-shi (JP); Masashi IGARASHI, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 11/834,212

(22) Filed: Aug. 6, 2007

(30) Foreign Application Priority Data
Aug. 8, 2006 (JP) 2006-215552

(51) Int. Cl. F16H 7/08

(52) U.S. Cl. 474/111

(57) ABSTRACT

A chain tensioner includes a tensioner slipper 11 includes a proximal end pivotally moving to press a chain 5. A restriction member 21 is fixed on a side opposite to the chain 5 relative to the tensioner slipper 11. The tensioner slipper 11 and the restriction member 21 have mutually opposing surfaces 11a, 21a formed to narrow gradually toward a center of pivotal motion of the tensioner slipper 11. A roller 15 is sandwiched between the tensioner slipper 11 and the restriction member 21. The roller 15 is urged by a spring 25 toward a side of the center 24 of pivotal motion of the tensioner slipper 11.

### BACKGROUND OF THE INVENTION

The present invention relates to a mechanical chain tensioner maintaining tension in a chain trained about sprockets.

Chain tensioners include a tensioner slipper disposed so as to abut a side surface of a chain and press the chain in opposition to tension of the chain, thereby keeping the chain in an appropriate taut condition at all times for smooth drive transmission.

As such, the foregoing arrangement makes it necessary to keep the chain taut even if the chain stretches to slack off with time, by making the tension slipper advance toward a side of the chain. The arrangement should also suppress wobble of the chain by adapting the tensioner slipper to be less easy to retract once it has advanced.

Japanese Utility Model Laid-Open No. Sho 55-127149 discloses a chain tensioner of the foregoing kind, adapted to offer a simple mechanical structure.

The known art disclosed in Japanese Utility Model Laid-Open No. Sho 55-127149 is concerned with “a chain tensioner including a cam pivotally movably supported with a shaft extending in parallel with a sprocket shaft, wherein a stop lever extending in parallel with the shaft is engaged in an arcuate guide slit made in the cam and fitted with a nut or other retaining member such that the cam can be secured in position and can elastically press in a direction of tensioning a chain.”

If the chain slacks off, the nut is loosened. This causes the cam to press elastically in the direction of tensioning the chain. Then, the nut is tightened to fix the cam in position.

In the art as disclosed in Japanese Utility Model Laid-Open No. Sho 55-127149, the cam that corresponds to the tensioner slipper advances to make the chain taut and is then fixed in position. The cam can therefore never retract. The art does not, however, let the cam automatically advance to keep the chain in a taut condition when the chain slacks off.

This requires that the chain be monitored for proper tension at all times. If the chain is built into a case, it is difficult to find a slack chain.

The known art also requires a stop lever, a nut, and other members for securing the cam. This results in an increased number of parts used and an increased cost.

The present invention has been made to address the foregoing problems and it is an object of the present invention to provide at low cost a simply constructed chain tensioner having a small number of parts used, capable of automatically keeping a chain in a taut condition in response to changes in the chain with time.

### SUMMARY OF THE INVENTION

To achieve the foregoing object, according to a first aspect of the present invention, there is provided a chain tensioner that includes a tensioner slipper adapted to press against a side surface of a chain trained about sprockets, thereby keeping the chain taut. In this chain tensioner, the tensioner slipper includes a proximal end pivotally moving to press the chain. A restriction member is fixed on a side opposite to the chain relative to the tensioner slipper. The distance between the tensioner slipper and the restriction member gradually narrows toward a center of pivotal motion of the tensioner slipper. An inserted member is sandwiched between the tensioner slipper and the restriction member. The inserted member is urged by a spring toward the center of pivotal motion of the tensioner slipper.

According to a second aspect of the present invention, in the chain tensioner according to the first aspect of the present invention, the inserted member is a roller. Further, the tensioner slipper includes a concave contact surface in contact with the roller and the restriction member includes a flat contact surface in contact with the roller.

According to a third aspect of the present invention, in the chain tensioner according to the second aspect of the present invention, the spring urges the roller eccentrically toward the concave contact surface of the tensioner slipper.

According to a fourth aspect of the present invention, in the chain tensioner according to the second or third aspect of the present invention, the concave contact surface of the tensioner slipper is a trochoid surface.

According to a fifth aspect of the present invention, in the chain tensioner according to any one of the first to fourth aspects of the present invention, at least one of both sides of the contact surface of the tensioner slipper in contact with the inserted member include a protruding guide portion, and both sides of the contact surface of the restriction member in contact with the inserted member includes protruding guide portions.

According to the chain tensioner of the first aspect of the present invention, the inserted member sandwiched between the tension slipped and the restriction member is urged by the spring toward the center of pivotal motion of the tensioner slipper. Accordingly, as the chain stretches with time, the inserted member moves, while pivotally moving the tensioner slipper, so as to bite into a space formed between the tensioner slipper and the tesriction member which narrows gradually. The tensioner slipper can thereby be made to advance in the chain tensioning direction, so that the automatically stretched chain can be pressed and kept in a taut condition.

The inserted member, which has bitten into the space between the tensioner slipper and the restriction member, is subject to a large friction in an advancing direction. As a result, the tensioner slipper, once advanced, is not likely to retract, so that wobble in the chain can be suppressed.

The arrangement according to the first aspect of the present invention requires no special means for securing the tensioner slipper, forms a simple mechanical structure, has a small number of parts used, and achieves reduction in cost.

According to the chain tensioner of the second aspect of the present invention, the roller as the inserted member is sandwiched between the concave surface of the tensioner slipper and the flat surface of the restriction member. When the chain slacks off and the roller is moved by the spring while pivotally moving the tensioner slipper, the roller moves so as to roll along the concave surface of the tensioner slipper and slip over the flat surface of the restriction member, while pivotally moving the tensioner slipper. This is because the roller receives a greater contact friction from the concave surface of the tensioner slipper than the flat surface of the restriction member. The tensioner slipper can thus be made to advance in the chain tensioning direction easily to maintain the chain in the taut condition. Meanwhile, the tensioner slipper, once advanced, is hard to retract.

According to the chain tensioner of the third aspect of the present invention, the spring urges the roller eccentrically toward the tensioner slipper. This increases pressure of the roller acting on the concave surface of the tensioner slipper, so that the roller can more easily roll without slipping over the concave surface.

According to the chain tensioner of the fourth aspect of the present invention, the concave surface included in the tensioner slipper forms a trochoid surface. This allows the roller to roll over the concave surface of the tensioner slipper even more easily, so that the tensioner slipper can pivotally advance in the chain tensioning direction easily and be even harder to retract.

According to the chain tensioner of the fifth aspect of the present invention, at least one of both sides of the contact surface of the tensioner slipper in contact with the inserted member includes a protruding guide portion and both sides of the contact surface of the restriction member in contact with the inserted member includes the protruding guide portions. The inserted member can therefore be prevented, by such a simple structure, from deviating in either direction of movement without being prevented from rolling.

### BRIEF DESCRIPTION OF THE DRAWINGS

FIG. 1 is a view showing schematically a chain tensioner and a chain power transmission mechanism according to an embodiment of the present invention;

FIG. 2 is a view showing schematically the chain tensioner and the chain power transmission mechanism with a chain thereof stretching with time; and

FIG. 3 is a cross-sectional view taken along line III-III of FIG. 1.

### DETAILED DESCRIPTION OF THE INVENTION

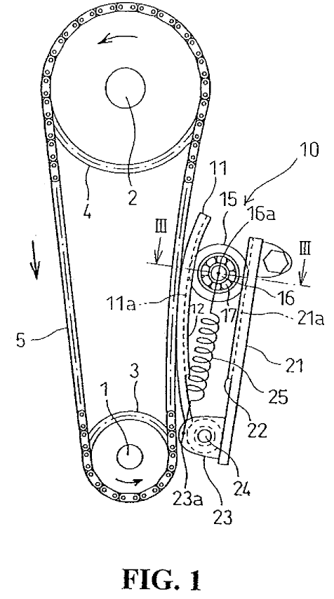

A specific embodiment to which the present invention is applied will be described below with reference to FIGS. 1 through 3.

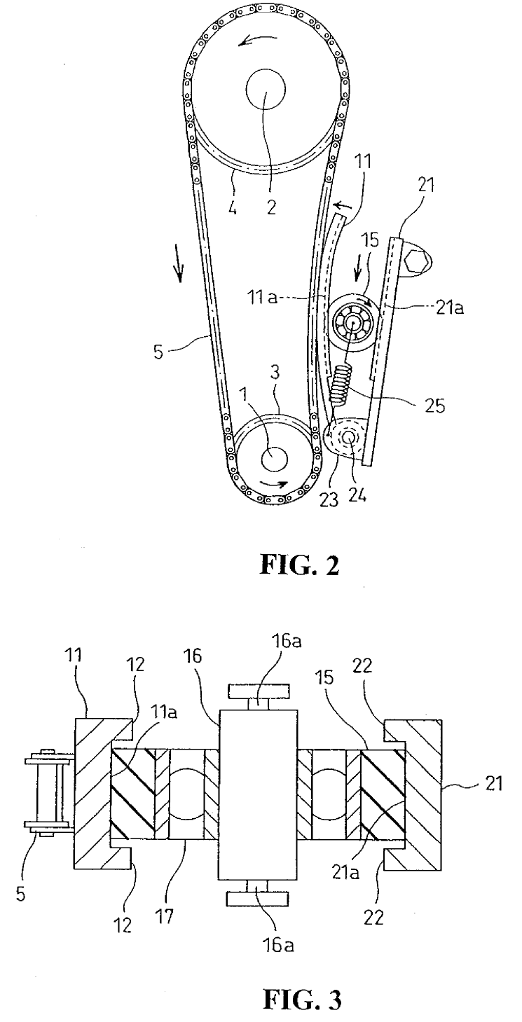

A chain tensioner 10 according to an embodiment of the present invention is applied to a power transmission mechanism transmitting power to a valve train of an internal combustion engine. In FIGS. 1 and 2, an engine case and surrounding parts are omitted.

A chain 5 is trained about a drive sprocket 3 and a driven sprocket 4. The drive sprocket 3 is fitted to a drive shaft 1 and the driven sprocket 4 is fitted to a driven shaft 2.

A tensioner slipper 11 abuts on a side surface of the chain 5 so as to follow therealong. A restriction plate 21 is fixed opposite to the chain, relative to the tensioner slipper 1, via a roller 15.

The restriction plate 21 is a long flat sheet. The restriction plate 21 includes a flat contact surface 21a in contact with the roller 15. Edges on both ends of the contact surface 21a protrude toward a side of the roller 15 to form guide flaps 22, 22 (see FIG. 3).

The restriction plate 21 includes a pair of brackets 23, 23 formed so as to protrude toward the side of the chain 5 from the both end edges of the contact surface 21a. The pair is disposed at a first end (lower end in FIGS. 1 and 2) in a longitudinal direction of the restriction plate 21.

A pivot 24 is placed across the pair of brackets 23, 23. The tensioner slipper 11 has a proximal end pivotally supported on the pivot 24.

The tensioner slipper 11 is curved to include a convex surface and a concave surface. The convex surface is disposed on the side of the chain 5 so as to follow along the side surface of the chain 5. The concave surface is disposed on the side of the roller 15.

Part of the concave surface of the tensioner slipper 11 on the side of the roller 15 is a contact surface 11a in contact with the roller 15. The contact surface 11a forms a trochoid surface.

A curve of the trochoid surface is a trajectory described by a fixed point on an outer peripheral surface of the roller 15 as the roller 15 rolls.

The distance between mutually opposing contact surfaces 11a, 21a of the tensioner slipper 11 and the restriction plate 21 narrows gradually toward the pivot 24 that serves as a center of pivotal motion of the tensioner slipper 11.

The roller 15 is sandwiched between the contact surfaces 11a, 21a, the distance therebetween narrowing gradually toward the pivot 24.

Both end edges of the contact surface 11a of the tensioner slipper 11 protrude toward the side of the roller 15 to form guide flaps 12, 12 (see FIG. 3).

The roller 15 is a cylindrical plastic ring rotatably disposed on a roller central shaft 16 via a bearing 17 (see FIG. 3).

Spring locks 16a, 16a are formed on both ends of the roller central shaft 16, Spring locks 23a, 23a are formed, on the other hand, at leading ends of the brackets 23, 23 disposed in a protruding condition on the first end of the restriction plate 21. First ends of extension springs 25, 25 are latched by the spring locks 16a, 16a on both ends of the roller central shaft 16. Second ends of the extension springs 25, 25 are latched by the spring locks 23a, 23a at the leading ends of the brackets 23, 23.

Referring to FIGS. 1 and 2, therefore, the roller 15 is urged by the extension springs 25, 25 eccentrically to the side of the tensioner slipper 11 on the side of the pivot 24 serving as the center of pivotal motion of the tensioner slipper 11.

Accordingly, an urging force applied by the extension springs 25, 25 to the roller 15 has a component that acts to press the roller 15 toward the side of the tensioner slipper 11, but not one acting to press the roller 15 toward the side of the restriction plate 21.

The chain tensioner 10 is constructed as described in the foregoing. Specifically, the distance between the contact surface 21a of the restriction plate 21 fixed in position and the contact surface 11a of the tensioner slipper 11 pivotally movable about the pivot 24 gradually narrow toward the pivot 24. The roller 15, which is urged by the extension springs 25, 25 toward the side of the pivot 24, is sandwiched between these contact surfaces 11a, 21a formed to narrow gradually. Consequently, as the roller 15 bites, the tensioner slipper 11 pivotally moves toward the side of the chain 5 to press the side surface of the chain 5, so that the chain 5 is taut. Smooth power transmission is thus achieved through stabilized rotation of the chain 5 without wobble or the like.

As the chain 5 stretches with time, the roller 15 sandwiched between the contact surfaces 11a, 21a formed to narrow gradually is urged eccentrically by the extension springs 25, 25 toward the side of the tensioner slipper 11 on the side of the pivot 24. As described earlier, having the component of force acting to press the roller 15 toward the side of the tensioner slipper 11, there is a large contact friction with the contact surface 11a on which the trochoid surface of the tensioner slipper 11 is formed. On the other hand, there is a small contact friction with the flat contact surface 21a of the restriction plate 21, toward which there is no component of force acting to press the roller 15. Consequently, the roller 15 rolls along the contact surface 11a of the tensioner slipper 11, on which the trochoid surface is formed, smoothly toward the side of the pivot 24, while slipping over the flat contact surface 21a of the restriction plate 21. Accordingly, the tensioner slipper 11 can be made to pivotally advance easily in a chain tensioning direction, automatically keeping the chain 5 in the taut condition.

FIG. 2 shows a condition in which the chain 5 stretches so that the roller 15 further bites into a space between the restriction plate 21 and the tensioner slipper 11, causing the tensioner slipper 11 to pivotally advance in the chain tensioning direction to press the chain 5.

Once the tensioner slipper 11 pivotally advances in the chain tensioning direction, the tensioner slipper 11 is hard to retract. Accordingly, stabilized rotation of the chain 5 can be maintained without allowing the chain 5 to wobble or otherwise move erratically.

The contact surface 11a of the tensioner slipper 11 and the contact surface 21a of the restriction plate 21 include the guide flaps 12, 22 protruding on both sides thereof. The roller 15 is therefore prevented, by such a simple structure, from deviating in either direction of movement without being prevented from rolling.

As described heretofore, the chain tensioner 10 requires no special means for securing the tensioner slipper 11, forms a simple mechanical structure, has a small number of parts used, and achieves reduction in cost.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one or ordinary skill in the art could be made without departing from the scope of the invention which is to be determined by the following claims.

We claim:

1. A chain tensioner for keeping a chain which is trained about at least a pair of sprockets taut, comprising:
a restriction member fixed with respect to said chain;
a tensioner slipper having a proximal end connected to said restriction member, and having a surface abutting against a side surface of the chain, the restriction member disposed opposite to the chain, relative to said tensioner slipper; and
an inserted member sandwiched between said tensioner slipper and said restriction member,
wherein a distance between said tensioner slipper and said restriction member gradually narrows toward a center of pivotal motion of said tensioner slipper, and
wherein said inserted member is urged toward the center of pivotal motion of said tensioner slipper by a spring.

2. The chain tensioner according to claim 1,
wherein said inserted member is a roller;
wherein said tensioner slipper includes a concave contact surface in contact with said roller; and
wherein said restriction member includes a flat contact surface in contact with said roller.

3. The chain tensioner according to claim 2,
wherein said spring urges said roller eccentrically toward said concave contact surface of said tensioner slipper.

4. The chain tensioner according to claim 2 or 3,
wherein said concave contact surface of said tensioner slipper is a trochoid surface.

5. The chain tensioner according to claim 1,
wherein at least one side of a contact surface of said tensioner slipper in contact with said inserted member includes a protruding guide portion, and
wherein both sides of a contact surface of said restriction member in contact with said inserted member include protruding guide portions.

6. The chain tensioner according to claim 2,
wherein at least one side of said concave contact surface of said tensioner slipper in contact with said inserted member includes a protruding guide portion, and
wherein both sides of said flat contact surface of said restriction member in contact with said inserted member include protruding guide portions.

7. The chain tensioner according to claim 3,
wherein at least one side of said concave contact surface of said tensioner slipper in contact with said inserted member includes a protruding guide portion, and
wherein both sides of said flat contact surface of said restriction member in contact with said inserted member include protruding guide portions.

8. The chain tensioner according to claim 4,
wherein at least one side of said concave contact surface of said tensioner slipper in contact with said inserted member includes a protruding guide portion, and
wherein both sides of said flat contact surface of said restriction member in contact with said inserted member include protruding guide portions.
